(19) United States
(12) Patent Application Publication
(10) Pub. No.: US 2012/0217682 A1
(43) Pub. Date: Aug. 30, 2012

(54) Methods of Improving the Physical Properties of Polyolefin Films

(75) Inventors: Eric Vignola, Calgary (CA); Daniel Purpura, Pittsburgh, PA (US); Paul Tas, Cochrane (CA); Jamie Marler, Calgary (CA)

(73) Assignee: NOVA CHEMICALS INC., Moon Township, PA (US)

(21) Appl. No.: 13/372,733

(22) Filed: Feb. 14, 2012

Related U.S. Application Data
(60) Provisional application No. 61/446,186, filed on Feb. 24, 2011.

(51) Int. Cl. B29C 39/14

(52) U.S. Cl. 264/555

(57) ABSTRACT

Methods of improving the physical properties of a polyolefin film that include providing interpolymer resin particles, forming a blend composition by blending from about 0.1 to about 25% by weight based on the weight of the blend composition of interpolymer resin particles into a second polyolefin; and forming a film from the blend composition. The interpolymer resin particles are made up a styrenic polymer intercalated within a first polyolefin. The first polyolefin is present at from about 20% to about 80% by weight based on the weight of the particles and the styrenic polymer is present at from about 20% to about 80% by weight based on the weight of the particles.

REFERENCE TO RELATED APPLICATION

This application claims the benefit of priority of U.S. Provisional Application Ser. No. 61/446,186 filed Feb. 24, 2011 entitled “Methods of Improving the Physical Properties of Polyolefin Films”, which is herein incorporated by reference in its entirety.

### BACKGROUND OF THE INVENTION

1. Field of the Invention

The present invention relates to polyolefin films. The films can be formed via sheet extrusion, cast film as blown film extrusion.

2. Background Art

Stretch films are widely used in a variety of bundling and packaging applications. The term “stretch film” indicates films capable of stretching and applying a bundling force, and includes films stretched at the time of application as well as “pre-stretched” films, i.e., films which are provided in a pre-stretched form for use without additional stretching. Stretch films can be monolayer films or multilayer films, and can include cling-enhancing additives such as tackifiers, and non-cling or slip additives, as desired, to tailor the slip/cling properties of the film. Typical polymers used in the cling layer of conventional stretch films include, for example, ethylene vinyl acetate, ethylene methyl acrylate, and very low density polyethylenes having a density of less than about 0.912 g/cm³.

It is desirable to maximize the degree to which a stretch film is stretched, as expressed by the percent of elongation of the stretched film relative to the unstretched film, and termed the “stretch ratio”. At relatively larger stretch ratios, the film imparts greater holding force. Further, films which can be used at larger stretch ratios with adequate holding force and film strength offer economic advantages, since less film is required for packaging or bundling.

The application of polyethylene films in stretch wrapping has been considerably enhanced by the use of linear low density polyethylene (LLDPE) type products. When formed into a film for stretch wrap application, LLDPE products typically combine a high extensibility with good mechanical properties to provide a wrapping or collation function to be achieved in an economic and effective manner. In this respect, LLDPE has significant advantages over LDPE which, due to both its behavior in extension and its mechanical performance, is not normally regarded as a product of choice for stretch wrapping applications.

For example, in a single layered or composite stretch film comprising a low density polyethylene or an ethylene/vinyl acetate copolymer, an elongation maximum of about 150% is often observed. If stretched more than that the film often breaks during the stretching.

In the case of a film made of a linear low density polyethylene, after wrapping, an excessive stress is likely to be exerted to a wrapped product, whereby the wrapped product or its tray is likely to be deformed, or the strength after wrapping tends to be weak, or the film tends to undergo non-uniform stretching, so that the appearance of a commercial product after wrapping tends to be poor. Some efforts to solve this problem have been to lower the density of the linear low density polyethylene, however, the resulting pellets or film tend to be excessively sticky, which causes problems during the production or handling of wrapped products after wrapping.

Application of stretch wrap films may be either by hand or by machine. The film may be either wrapped directly onto the article or articles to be packaged, or it may undergo a pre-stretching operation prior to wrapping. Pre-stretching typically enhances the mechanical property of the film and provides a more effective packaging and more efficient coverage for a given unit mass of film. Hence, the response of the film to either a pre-stretch or the stretch applied during wrapping is an important parameter affecting film performance. In particular, for a given film width and thickness the efficiency with which an object is wrapped is affected by the degree to which the film can be thinned during the stretching and the loss of film width which may occur at the same time. The resistance to sudden impact events, puncture by sharp objects and the ability to maintain a tension sufficient to maintain the package in the desired shape and configuration are also important parameters.

A further requirement in many stretch wrapping applications is that the film displays a certain degree of adhesive or cling behavior enabling a film closure of the package to be achieved without resort to use of additional securing measures such as straps, glues or heat sealing operations. For monolayer films, such adhesion may be provided by the intrinsic film properties or by using a “cling” additive in the film formulation. An example of a cling additive which is widely used is poly(isobutene) (PIB) which term is taken to include polybutenes produced from mixed isomers of butene. For multi-layer films, it is relatively easy to provide one or more surface layers which are specifically formulated to provide cling. In general, this method allows a more flexible approach to film manufacture as choice of product for the main body of the film may be made on the basis of mechanical performance and the surface layers can be specially formulated for adhesion. Those skilled in the art will appreciate the multiplicity and flexibility of the choices of possible film structures.

In some stretch films, as the film is stretched, a small decrease in the film thickness due to small fluctuations in thickness uniformity can result in a large fluctuation in elongation, giving rise to bands of weaker and more elongated film transverse to the direction of stretching, a defect known as “tiger striping”. Thus, it is desirable to avoid tiger striping over typical thickness variations of, for example, ±5%. In addition, since the extent of elongation correlates inversely with the amount of film that must be used to bundle an article, it is desirable for the film to be stretchable to a large elongation. In principle, the elongation at break is the maximum possible elongation. Thus, it is desirable to have a large elongation to break. Other desirable properties include, but are not limited to, high cling force and good puncture resistance.

While prior efforts have resulted in films having improved performance in one or several of the above-described properties, known films have not successfully displayed the combination of mechanical strength such as puncture resistance, breaking strength or elongation at break, stretchability, and elastic recovery. Such properties are needed for stretch packaging films useful for packaging products applied by a hand wrapper or a stretch wrapping machine.

### SUMMARY OF THE INVENTION

The present invention is directed to methods of improving the physical properties of a polyolefin film. The method includes providing interpolymer resin particles, forming a blend composition by blending from about 0.1 to about 25 percent by weight based on the weight of the blend composition of interpolymer resin particles into a second polyolefin; and forming a film from the blend composition. The interpolymer resin particles are made up of a styrenic polymer intercalated within a first polyolefin. The first polyolefin is present at from about 20% to about 80% by weight based on the weight of the particles and the styrenic polymer is present at from about 20% to about 80% by weight based on the weight of the particles.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term “blown film techniques” refers to polyolefin films produced by blown film extrusion. In this process, the resin is plasticized in an extruder and pumped through an annular die. The molten extrudate emerging out of the die in the form of a tube is inflated by air into a bubble of the desired diameter. It is then cooled by air, hauled off through collapsing boards and nip rolls to give a lay flat tubing, which is subsequently wound into rolls.

As used herein, the term “cast film techniques” refers to polyolefin films where the polymer melt from the extruder is fed into a wide flat die. The extrudate comes out of the die as a thin, wide curtain of film. This molten curtain is cast directly into a quench tank or onto a chill roll. A nip roll arrangement then pulls the film, which is latter wound into rolls.

As used herein, the term “continuous phase” refers to a material into which an immiscible material is dispersed. In embodiments of the present invention, polyolefins provide a continuous phase into which a monomer mixture is dispersed. In other embodiments of the invention, polyolefin particles are dispersed in an aqueous continuous phase during polymerization.

As used herein, the term “dispersed phase” refers to a material in droplet or particulate form which is distributed within an immiscible material. In embodiments of the present invention, a monomer mixture provides a dispersed phase in a continuous phase containing one or more polyolefins. In other embodiments of the invention, the present interpolymer resin particles make up a dispersed phase within a thermoplastic, in many cases a polyolefin, continuous phase.

As used herein, the term “elastomer” refers to materials that have the ability to undergo deformation under the influence of a force and regain its original shape once the force is removed. In many embodiments of the invention, elastomers include homopolymers and copolymers containing polymerized residues derived from isoprene and/or butadiene.

As used herein, the term “intercalated” refers to the insertion of one or more polymer molecules within the domain of one or more other polymer molecules having a different composition. In embodiments of the invention, as described herein below, styrenic polymers are inserted into polyolefin particles by polymerizing a styrenic monomer mixture within the polyolefin particles.

As used herein, the term “HDPE” refers to high density polyethylene, which generally has a density of greater or equal to 0.941 g/cm³. HDPE has a low degree of branching. HDPE is often produced using chromium/silica catalysts, Ziegler-Natta catalysts or metallocene catalysts.

As used herein, the term “LDPE” refers to low density polyethylene, which is a polyethylene with a high degree of branching. Often, the density of a LDPE will range from 0.910-0.940 g/cm³. LDPE can be created by free radical polymerization.

As used herein, the term “LLDPE” refers to linear low density polyethylene, which is a polyethylene with significant numbers of short branches resulting from copolymerization of ethylene with at least one C₃₋₁₂ α-olefin comonomer, e.g., butene, hexene or octene. Typically, LLDPE has a density in the range of 0.915-0.925 g/cm³. In many cases, the LLDPE is an ethylene hexene copolymer, ethylene octene copolymer or ethylene butene copolymer. The amount of comonomer incorporated can be from 0.5 to 12 mole %, in some cases from 1.5 to 10 mole %, and in other cases from 2 to 8 mole % relative to ethylene.

As used herein, the term “MDPE” refers to medium density polyethylene, which is a polyethylene with some branching and a density in the range of 0.926-0.940 g/cm³. MDPE can be produced using chromium/silica catalysts, Ziegler-Natta catalysts or metallocene catalysts.

As used herein, the term “VLDPE” refers to very low density polyethylene, which is a polyethylene with high levels of short chain branching with a typical density in the range of 0.880-0.915 g/cc. In many cases VLDPE is a substantially linear polymer. VLDPE is typically produced by copolymerization of ethylene with short-chain alpha-olefins (e.g., 1-butene, 1-hexene, or 1-octene). VLDPE is most commonly produced using metallocene catalysts.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “monomer” refers to small molecules containing at least one double bond that reacts in the presence of a free radical polymerization initiator to become chemically bonded to other monomers to form a polymer.

As used herein, the term, “olefinic monomer” includes, without limitation, α-olefins, and in particular embodiments ethylene, propylene, 1-butene, 1-hexene, 1-octene and combinations thereof.

As used herein, the term, “physical properties” refers to characteristics of the films described herein relative to the strength, puncture resistance, rheology and deformation properties. Non-limiting examples of film physical properties include processability, throughput, impact properties, tensile properties, yield properties, creep properties, modulus values, tear properties, elongation properties, and flexural properties.

As used herein, the term “polyolefin” refers to a material, which is prepared by polymerizing a monomer composition containing at least one olefinic monomer.

As used herein, the term “polyethylene” includes, without limitation, homopolymers of ethylene and copolymers of ethylene and one or more of propylene, 1-butene, 1-hexene and 1-octene.

As used herein, the term “polymer” refers to macromolecules composed of repeating structural units connected by covalent chemical bonds and is meant to encompass, without limitation, homopolymers, random copolymers, block copolymers and graft copolymers.

As used herein, the term “styrenic polymer” refers to a polymer derived from polymerizing a mixture of one or more monomers that includes at least 50 wt. % of one or more monomers selected from styrene, p-methyl styrene, α-methyl styrene, tertiary butyl styrene, dimethyl styrene, nuclear brominated or chlorinated derivatives thereof and combinations thereof.

As used herein, the term “thermoplastic” refers to a class of polymers that soften or become liquid when heated and harden when cooled. In many cases, thermoplastics are high-molecular-weight polymers that can be repeatedly heated and remolded. In many embodiments of the invention, thermoplastic resins include polyolefins and elastomers that have thermoplastic properties.

As used herein, the terms “thermoplastic elastomers” and “TPE” refer to a class of copolymers or a blend of polymers (in many cases, a blend of a thermoplastic and a rubber) which includes materials having both thermoplastic and elastomeric properties.

As used herein, the terms “thermoplastic olefin” or “TPO” refer to polymer/filler blends that contain some fraction of polyethylene, polypropylene, block copolymers of polypropylene, rubber, and a reinforcing filler. The fillers can include, without limitation, talc, fiberglass, carbon fiber, wollastonite, and/or metal oxy sulfate. The rubber can include, without limitation, ethylene-propylene rubber, EPDM (ethylene-propylene-diene rubber), ethylene-butadiene copolymer, styrene-ethylene-butadiene-styrene block copolymers, styrene-butadiene copolymers, ethylene-vinyl acetate copolymers, ethylene-alkyl(meth)acrylate copolymers, very low density polyethylene such as those available under the Flexomer® resin trade name from the Dow Chemical Co., Midland, Mich., styrene-ethylene-ethylene-propylene-styrene (SEEPS). These can also be used as the materials to be modified by the interpolymer to tailor their rheological properties.

Unless otherwise specified, all molecular weight values are determined using gel permeation chromatography (GPC). Typically, the GPC analysis is done using an instrument sold under the tradename “Waters 150c”. For polystyrene, the samples are dissolved in toluene, which is the mobile phase, and the results compared against appropriate polystyrene standards. For polyethylene, the samples are dissolved in 1,2,4-trichlorobenzene, the mobile phase at 140° C. The samples are prepared by dissolving the polymer in this solvent and run without filtration. Molecular weights are expressed as polyethylene equivalents with a relative standard deviation of 2.9% for the number average molecular weight (“Mn”) and 5.0% for the weight average molecular weight (“Mw”). Unless otherwise indicated, the molecular weight values indicated herein are weight average molecular weights (Mw).

The present invention is directed to a film containing a polymer composition that includes from about 0.1 to about 50 percent by weight of interpolymer resin particles and from about 50 to about 99.9 percent by weight of at least one polyolefin. The interpolymer resin particles include a styrenic polymer intercalated within a polyolefin. The interpolymer resin particles contain from about 20% to about 80% by weight based on the weight of the particles of a polyolefin and from about 20% to about 80% by weight based on the weight of the particles of the styrenic polymer.

The present invention also provides a film containing a polymer composition that includes interpolymer resin particles that include a styrenic polymer intercalated within a polyolefin and at least one polyolefin. In aspects of the invention, the films show improved Dart impact properties as well as higher tensile yield strength and modulus values.

The interpolymer resin particles have little or no gel content. In embodiments of the invention, the interpolymer resin particles can have, at least in part, a crystalline morphology. The interpolymer resin includes a polyolefin and an intercalated polymer that contains repeat units derived from one or more styrenic monomers.

In particular embodiments of the invention, the interpolymer resin particles can include the unexpanded interpolymer resin particles described in U.S. Pat. No. 7,411,024, the disclosure of which is incorporated herein by reference in its entirety.

In embodiments of the invention, the interpolymer resin particles include at least about 20, in some cases at least about 25, in other cases at least about 30, in some instances at least about 35 and in other instances at least about 40 wt. % of one or more polyolefins. Also, the interpolymer resin particles include up to about 80, in some instances up to about 60, in some cases up to about 55, and in other cases up to about 50 wt. % of one or more polyolefins. The polyolefin content of the interpolymer resin particles can be any value or range between any of the values recited above.

In embodiments of the invention, the polyolefin in the interpolymer resin particles includes one or more of polyethylene, polypropylene, ethylene-vinyl acetate copolymers, thermoplastic olefins (TPO's), and thermoplastic elastomers (TPE's) resins. In particular embodiments of the invention, the polyethylene is one or more of linear low density polyethylene and low density polyethylene. Suitable polyolefins are those that provide for desirable properties in the interpolymer resin particles, and in particular in the polyolefin films as described herein.

In embodiments of the invention, the polyethylene can include a homopolymer of ethylene, ethylene copolymers that include at least 50 mole % and in some cases at least 70 mole %, of an ethylene unit and a minor proportion of a monomer copolymerizable with ethylene, ethylene-vinyl acetate copolymers, HDPE, LDPE, LLDPE, VLDPE, and a blend of at least 50% by weight, in many cases at least 60% by weight, of the ethylene homopolymer or copolymer with another polymer.

Non-limiting examples of monomers copolymerizable with ethylene include vinyl acetate, vinyl chloride, propylene, butene, hexene, octene, (meth)acrylic acid and its esters, butadiene, isoprene, styrene and combinations thereof.

Non-limiting examples of the other polymer that may be blended with the ethylene homopolymer or copolymer include any polymer compatible with it. Non-limiting examples include polypropylene, polybutadiene, polyisoprene, polychloroprene, chlorinated polyethylene, polyvinyl chloride, a styrene/butadiene copolymer, a vinyl acetate/ethylene copolymer, an acrylonitrile/butadiene copolymer, a vinyl chloride/vinyl acetate copolymer, etc. In many cases, the other polymers are polypropylene, polybutadiene, styrene/butadiene copolymer and combinations thereof.

Non-limiting examples of polyethylene that can be included in the interpolymer resin particles include low-, medium-, and high-density polyethylene, an ethylene vinyl acetate copolymer, an ethylene/propylene copolymer, a blend of polyethylene and polypropylene, a blend of polyethylene and an ethylene/vinyl acetate copolymer, and a blend of polyethylene and an ethylene/propylene copolymer.

In embodiments of the invention, the polyethylene resin particles used to form the interpolymer resin particles of the invention can have a melt index (MI) of about 0.3 to 15, in some cases 0.3 to 10 and in other cases 0.3 to 5 g/10 minutes under 190° C./2.16 kg conditions (equivalent to 11.9 g/10 minutes under 230° C./5.0 kg conditions) (ASTM D1238); a number average molecular weight of 20,000 to 60,000; an intrinsic viscosity, at 75° C. in xylene, of 0.8 to 1.1; a density of 0.910 to 0.940 g/cm³, and a VICAT softening temperature greater than 60° C., in some cases greater than 70° C. and in other cases greater than 85° C.

In embodiments of the invention, the polyolefin of the interpolymer resin has a VICAT softening temperature greater than 85° C., in some cases at least about 90° C. and in other cases at least about 95° C. and can be up to about 115° C.

In embodiments of the invention, the polyolefin of the interpolymer resin has a melt flow of at least 0.2, in some cases at least about 0.5, in other cases at least about 1.0, in some instances at least about 2.1, in other instance at least about 2.5, in some situations at least about 3.0 and in other situations at least about 4.0 g/10 minutes (230° C., 2.16 kg under ASTM D-1238).

The styrenic polymer is a polymer derived from polymerizing a monomer mixture of one or more styrenic monomers and optionally one or more other monomers. Any suitable styrenic monomer can be used in the invention. Suitable styrenic monomers are those that provide the desirable properties in the present interpolymer resin particles as described below. Non-limiting examples of suitable styrenic monomers include styrene, p-methyl styrene, α-methyl styrene, ethyl styrene, vinyl toluene, tertiary butyl styrene, isopropylxylene, dimethyl styrene, nuclear brominated or chlorinated derivatives thereof and combinations thereof.

When the monomer mixture includes other monomers, the styrenic monomers are present in the monomer mixture at a level of at least 50%, in some cases at least 60% and in other cases at least 70% and can be present at up to 99%, in some cases up to 95%, in other cases up to 90%, and in some situations up to 85% by weight based on the monomer mixture. The styrenic monomers can be present in the monomer mixture at any level or can range between any of the values recited above.

Suitable other monomers that can be included in the monomer mixture include, without limitation, maleic anhydride, C₁-C₄ alkyl(meth)acrylates, acrylonitrile, vinyl acetate, and combinations thereof.

When the monomer mixture includes other monomers, the other monomers are present in the monomer mixture at a level of at least 1%, in some cases at least 5%, in other cases at least 10%, in some instances at least 15%, in other instances at least 20%, in some situations at least 25% and in other situations at least 30% and can be present at up to 50%, in some cases up to 40%, and in other cases up to 30% by weight based on the monomer mixture. The other monomers can be present in the monomer mixture at any level or can range between any of the values recited above.

In embodiments of the invention, the interpolymer resin particles include at least about 40, in some cases at least about 45 and in other cases at least about 50 wt. % of one or more styrenic polymers. Also, the interpolymer resin particles include up to about 80, in some cases up to about 75, in other cases up to about 70, in some instances up to about 65 and in other instances up to about 60 wt. % of one or more styrenic polymers. The styrenic polymer content of the interpolymer resin particles can be any value or range between any of the values recited above.

In embodiments of the invention, cross-linking of the polyolefin resin particles is minimized or eliminated as reflected by the gel content in the interpolymer resin. In particular embodiments of the invention, the gel content of the interpolymer resin is 0 and can be up to about 5 wt. %, in other cases up to about 2.5 wt. %, in other cases up to about 1.5 wt. %, in some instances up to about 1 wt. % and in other instances up to about 0.5 wt. %. The gel content of the interpolymer resin can range between 0 and any of the values recited above.

In many embodiments of the invention, the polyolefin in the interpolymer resin particles is not crosslinked.

In embodiments of the invention, the VICAT softening temperature of the interpolymer resin particles can be at least about 85° C., in some cases at least about 90° C., and in other cases at least about 95° C. and can be up to about 115° C., in some cases up to about 110° C. and in other cases at least about 105° C. The VICAT softening temperature of the interpolymer resin particles can be any value or range between any of the values recited above.

In embodiments of the invention, the melt index value of the interpolymer resin particles can be at least about 0.1, in some cases at least about 0.25, and in other cases at least about 0.5 g/10 minutes (230° C./5.0 kg) and can be up to about 4, in some cases up to about 3, in other cases up to about 2.5, in some instances up to about 2 and in some instances up to about 1.5 g/10 minutes (230° C./5.0 kg). The melt index value of the interpolymer resin particles can be any value or range between any of the values recited above.

In embodiments of the invention, the interpolymer resin particles are prepared using a process that includes: providing the above described polyolefin resin particles suspended in an aqueous medium; minimizing or eliminating cross-linking in the polyolefin resin particles; adding to the aqueous suspension a monomer mixture that includes a vinyl aromatic monomer, and a polymerization initiator for polymerizing the monomer mixture within the polyolefin resin particles; and polymerizing the monomer mixture in the polyolefin resin particles to form the interpolymer resin particles.

In embodiments of the invention, the interpolymer resin particles are formed as follows: in a reactor, the polyolefin resin particles are dispersed in an aqueous medium prepared by adding 0.01 to 5%, in some cases 2 to 3%, by weight based on the weight of the water of a suspending or dispersing agent such as water soluble high molecular materials, e.g., polyvinyl alcohol, methyl cellulose, and slightly water soluble inorganic materials, e.g., calcium phosphate or magnesium pyrophosphate, and then the vinyl aromatic monomers are added to the suspension and polymerized inside the polyolefin resin particles to form an interpenetrating network of polyolefin and polymer of vinyl aromatic monomers.

Any suitable vinyl aromatic monomer can be used in the invention. Examples of suitable vinyl aromatic monomers include, but are not limited to styrene, α-methylstyrene, ethylstyrene, chlorostyrene, bromostyrene, vinyltoluene, vinylbenzene, and combinations thereof. These monomers may be used either alone or in admixture. A mixture of at least 0.1% of the vinyl aromatic monomer and a monomer copolymerizable with it, such as acrylonitrile, methyl(meth)acrylate, butyl(meth)acrylate, or methyl(meth)acrylate can also be used. As used herein, the term “vinyl aromatic monomer” means a vinyl aromatic monomer used alone or in admixture.

In many embodiments of the invention, the vinyl aromatic monomer is styrene polymerized within the polyolefin resin particles.

Any of the conventionally known and commonly used suspending agents for polymerization can be employed. These agents are well known in the art and may be freely selected by one skilled in the art. Water is used in an amount generally from 0.7 to 5, in many cases 3 to 5 times that of the starting polyolefin particles added to the aqueous suspension, on a weight basis.

When the polymerization of the vinyl aromatic monomer is completed, the polymerized vinyl aromatic resin is uniformly dispersed inside the polyolefin particles.

Methods of preparing the interpolymer resin particles are disclosed, as a non-limiting example, in U.S. Pat. No. 7,411,024.

The interpolymer resin particles of the invention may suitably be coated with compositions comprising silicones, metal or glycerol carboxylates, suitable carboxylates are glycerol mono-, di- and tri-stearate, zinc stearate, calcium stearate, and magnesium stearate; and mixtures thereof. Examples of such compositions may be those disclosed in GB Patent No. 1,409,285 and in Stickley U.S. Pat. No. 4,781,983. The coating composition can be applied to the interpolymer resin particles via dry coating or via a slurry or solution in a readily vaporizing liquid in various types of batch and continuous mixing devices. The coating aids in transferring the interpolymer resin particles easily through the processing equipment.

The interpolymer resin particles can contain other additives, which can include, without limitation, chain transfer agents, nucleating agents, agents that enhance biodegradability and other polymers.

Suitable chain transfer agents include, but are not limited to, C₂₋₁₅ alkyl mercaptans, such as n-dodecyl mercaptan, t-dodecyl mercaptan, t-butyl mercaptan and n-butyl mercaptan, and other agents such as pentaphenyl ethane and the dimer of α-methyl styrene, and combinations thereof.

Suitable nucleating agents, include, but are not limited to, polyolefin waxes. The polyolefin waxes, which include without limitation, polyethylene waxes, have a weight average molecular weight of from 250 to 5,000 and are typically finely divided through the polymer matrix in a quantity of 0.01 to 2.0% by weight, based on the interpolymer resin composition. The interpolymer resin particles can also contain from 0.1 to 0.5% by weight based on the interpolymer resin, talc, organic bromide-containing compounds, and polar agents as described in WO 98/01489, which include isalkylsulphosuccinates, sorbital-C₈₋₂₀-carboxylates, and C₈₋₂₀-alkylxylene sulphonates.

In some embodiments of the invention, other materials such as elastomers and additives can be added in whole or part to the interpolymer resin particles.

In various embodiments of the invention, various materials or additives are added to the interpolymer resin particles so that it acts as a carrier for the materials or additives.

In embodiments of the invention, a film having improved physical properties is desired. In these embodiments, the interpolymer resin particles are generally present in the polymer blend composition at a level of at least about 0.1 wt. %, in some cases at least about 0.25 wt. %, in other cases at least about 0.5 wt. %, in some instances at least about 0.75 wt. %, in other instances at least about 1 wt. %, in some situations at least about 1.25 wt. % and in other situations at least about 1.5 wt. % and can be up to about 25 wt. %, in some cases up to about 20 wt. % in other cases up to about 15 wt. % in some instances up to about 12.5 wt. %, in other instances up to about 10 wt. % and in some situations up to about 5 wt. % of the polymer composition. The amount of interpolymer resin particles in the polymer composition will vary depending on the particular second polyolefin used in the composition. The amount of interpolymer resin particles in the polymer composition can be any value or range between any of the values recited above.

The second polyolefin is generally present in the polymer blend composition at a level of at least about 75 wt. %, in some cases at least about 80 wt. %, in other cases at least about 85 wt. %, in some instances at least about 82.5 wt. %, in other instances at least about 90 wt. %, and in some situations at least about 95 wt. % and can be up to about 99.9 wt. %, in some cases up to about 99.75 wt. % in other cases up to about 99.5 wt. % in some instances up to about 99.25 wt. %, in other instances up to about 99 wt. % and in some situations up to about 98.5 wt. % of the polymer blend composition. The amount of interpolymer resin particles in the polymer blend composition will vary depending on the particular interpolymer resin particles used in the composition as well as the particular properties desired in the final film. The amount of second polyolefin in the polymer blend composition can be any value or range between any of the values recited above.

The present invention is directed to a film containing a polymer composition that includes interpolymer resin particles that include a styrenic polymer intercalated within a polyolefin and at least one polyolefin. In aspects of the invention, the films show improved physical properties, for example higher Dart impact, tensile yield strength and modulus values.

As indicated above, the film according to the present invention contains a polymer composition that includes the above-described interpolymer resin particles and at least one polyolefin, referred to herein as the “second polyolefin” in order to avoid confusion with the polyolefin in the interpolymer resin particles. In many embodiments of the invention, the second polyolefin is selected from polyethylene, copolymers of ethylene, polypropylene and copolymers of propylene.

In embodiments of the invention, when the second polyolefin is polyethylene, the polyethylene is one or more of homopolyethylene; copolymers of ethylene and one or more C₃-C₁₀-α-olefins, copolymers of ethylene and one or more C₁-C₄-alkyl(meth)acrylates; copolymers of ethylene and acrylonitrile; copolymers ethylene and vinyl acetate; copolymers of ethylene and butadiene; copolymers ethylene and isoprene; copolymers of ethylene and maleic anhydride; and combinations thereof.

In some embodiments of the invention, the second polyolefin can be a homopolymer of ethylene, ethylene copolymers that include at least 50 mole % and in some cases at least 70 mole %, of an ethylene unit and a minor proportion of a monomer copolymerizable with ethylene, ethylene-vinyl acetate copolymers, HDPE, LDPE, LLDPE, VLDPE, and a blend of at least 50% by weight, in many cases at least 60% by weight, of an ethylene homopolymer or copolymer with another polymer.

Non-limiting examples of monomers copolymerizable with ethylene include vinyl acetate, vinyl chloride, propylene, butene, hexene, octene, (meth)acrylic acid and its esters, butadiene, isoprene, styrene and combinations thereof.

Non-limiting examples of the other polymer that can be blended with the ethylene homopolymer or copolymer include any polymer compatible with it. Non-limiting examples include polypropylene, polybutadiene, polyisoprene, polychloroprene, chlorinated polyethylene, polyvinyl chloride, a styrene/butadiene copolymer, a vinyl acetate/ethylene copolymer, an acrylonitrile/butadiene copolymer, a vinyl chloride/vinyl acetate copolymer, etc. In many cases, the other polymer that can be blended with the ethylene homopolymer or copolymer is polypropylene, polybutadiene, styrene/butadiene copolymer and combinations thereof.

Particularly, non-limiting examples of polyolefins that the second polyolefin can include are low-density polyethylene, medium-density polyethylene, and high-density polyethylene, an ethylene vinyl acetate copolymer, an ethylene/propylene copolymer, a blend of polyethylene and polypropylene, a blend of polyethylene and an ethylene/vinyl acetate copolymer, and a blend of polyethylene and an ethylene/propylene copolymer.

In other embodiments of the invention, the polypropylene is one or more of homopolypropylene; copolymers of propylene and one or more C₂-C₁₀-α-olefins, copolymers of propylene and one or more C₁-C₄-alkyl(meth)acrylates; copolymers of propylene and acrylonitrile; copolymers propylene and vinyl acetate; copolymers of propylene and butadiene; copolymers propylene and isoprene; copolymers of propylene and maleic anhydride; and combinations thereof.

In other embodiments of the invention, the second polyolefin can be a homopolymer of an α-olefin or a copolymer of two or more α-olefins. In particular embodiments, the polyolefin includes one or more polymers selected from polyethylene, polypropylene, and copolymers of ethylene and/or propylene with 1-butene, 1-hexene, 1-octene and combinations thereof.

Non-limiting examples of suitable second polyolefins include the polyethylenes available under the SURPASS trade name from NOVA Chemicals and those available under the ELITE trade name available from the Dow Chemical Company as well as those available commercially under the trade names SCLAIR, NOVAPOL and SURPASS from NOVA Chemicals and BORSTAR from Borealis AG.

More particular, non-limiting examples of polyolefins that the second polyolefin can include are a low-density polyethylene (LDPE) resin available from NOVA Chemicals Inc. under the trade name NOVAPOL® LA-0218-AF and linear low-density polyethylene (LLDPE) resins NOVAPOL TD-9022-C, SCLAIR® FG220-A, SCLAIR FP120-C, SURPASS® FPs117-C and SURPASS FPs317-A also available from NOVA Chemicals.

The polymer composition described herein can be used to make the present films using polymer processing techniques, such as sheet extrusion, cast film and blown film extrusion. A sheet or layer formed from the polymer composition of the invention may be part of a multi-layer structure.

When the polymer composition is used in extrusion processing, particles of the polymer composition can be fed into an extruder, and then extruded as a single layer or co-extruded into multi-layer structures, e.g., sheet or film.

Thus, multi-layer structures according to the invention can be made by co-extruding or laminating one or more layers over at least one surface of the film containing the present polymer blend composition to form a multilayer film structure.

In some embodiments of the invention a polymer blend composition can be made by preparing a first blend of the interpolymer resin particles with one or more second polyolefins and then blending the first blend into one or more second polyolefins that can be the same or different than the second polyolefin in the first blend.

The polymer composition can optionally include, depending on its intended use, additives and adjuvants, which can include, without limitation, anti-blocking agents, antioxidants, anti-static additives, activators, biodegradation enhancers, zinc oxide, chemical foaming agents, colorants, dyes, filler materials, flame retardants, heat stabilizers, impact modifiers, light stabilizers, light absorbers, lubricants, nucleating agents, pigments, plasticizers, processing aids, slip agents, softening agents, and combinations thereof.

Suitable anti-blocking agents, slip agents and lubricants include without limitation silicone oils, liquid paraffin, synthetic paraffin, mineral oils, petrolatum, petroleum wax, polyethylene wax, hydrogenated polybutene, higher fatty acids and the metal salts thereof, linear fatty alcohols, glycerine, sorbitol, propylene glycol, fatty acid esters of monohydroxy or polyhydroxy alcohols, phthalates, hydrogenated castor oil, beeswax, acetylated monoglyceride, hydrogenated sperm oil, ethylenebis fatty acid esters, and higher fatty amides. Suitable lubricants include, but are not limited to, ester waxes such as the glycerol types, the polymeric complex esters, the oxidized polyethylene type ester waxes and the like, metallic stearates such as barium, calcium, magnesium, zinc and aluminum stearate, salts of 12-hydroxystearic acid, amides of 12-hydroxystearic acid, stearic acid esters of polyethylene glycols, castor oil, ethylene-bis-stearamide, ethylene bis cocamide, ethylene bis lauramide, pentaerythritol adipate stearate and combinations thereof in an amount of from 0.1 to 2 wt. % of the polymer blend composition.

Suitable antioxidants include without limitation Vitamin E, citric acid, ascorbic acid, ascorbyl palmitrate, butylated phenolic antioxidants, tert-butylhydroquinone (TBHQ) and propyl gallate (PG), butylated hydroxyanisole (BHA), butylated hydroxytoluene (BHT), and hindered phenolics such as IRGANOX® 1010 and IRGANOX 1076 available from Ciba Specialty Chemicals Corp., Tarrytown, N.Y.

Suitable anti-static agents include, without limitation, glycerine fatty acid, esters, sorbitan fatty acid esters, propylene glycol fatty acid esters, stearyl citrate, pentaerythritol fatty acid esters, polyglycerine fatty acid esters, and polyoxethylene glycerine fatty acid esters in an amount of from 0.01 to 2 wt. % of the polymer blend composition.

Suitable colorants, dyes and pigments are those that do not adversely impact the desirable physical properties of the polymer blend composition include, without limitation, white or any colored pigment. In embodiments of the invention, suitable white pigments contain titanium oxide, zinc oxide, magnesium oxide, cadmium oxide, zinc chloride, calcium carbonate, magnesium carbonate, kaolin clay and combinations thereof in an amount of 0.1 to 20 wt. % of the polymer blend composition. In embodiments of the invention, the colored pigment can include carbon black, phthalocyanine blue, Congo red, titanium yellow or any other colored pigment typically used in the printing industry in an amount of 0.1 to 20 wt. % of the polymer blend composition. In embodiments of the invention, the colorants, dyes and pigments include inorganic pigments including, without limitation, titanium dioxide, iron oxide, zinc chromate, cadmium sulfides, chromium oxides and sodium aluminum silicate complexes. In embodiments of the invention, the colorants, dyes and pigments include organic type pigments, which include without limitation, azo and diazo pigments, carbon black, phthalocyanines, quinacridone pigments, perylene pigments, isoindolinone, anthraquinones, thio-indigo and solvent dyes.

Suitable fillers are those that do not adversely impact, and in some cases enhance, the desirable physical properties of the polymer blend composition. Suitable fillers, include, without limitation, talc, silica, alumina, calcium carbonate in ground and precipitated form, barium sulfate, talc, metallic powder, glass spheres, barium stearate, calcium stearate, aluminum oxide, aluminum hydroxide, glass, clays such as kaolin and montmorolites, mica, silica, alumina, metallic powder, glass spheres, titanium dioxide, diatomaceous earth, calcium stearate, aluminum oxide, aluminum hydroxide, carbon nanotubes and fiberglass, and combinations thereof can be incorporated into the polymer composition in order to reduce cost or to add desired properties to the polymer blend composition. The amount of filler is desirably less than 10% of the total weight of the polymer blend composition as long as this amount does not alter the properties of the polymer blend composition.

Suitable flame retardants include, without limitation, brominated polystyrene, brominated polyphenylene oxide, red phosphorus, magnesium hydroxide, magnesium carbonate, antimony pentoxide, antimony trioxide, sodium antimonite, zinc borate and combinations thereof in an amount of 0.1 to 2 wt. % of the polymer blend composition.

Suitable heat stabilizers include, without limitation, phosphite or phosphonite stabilizers and hindered phenols, non-limiting examples being the IRGANOX® stabilizers and antioxidants available from Ciba Specialty Chemicals. When used, the heat stabilizers are included in an amount of 0.1 to 2 wt. % of the polymer blend composition.

Suitable impact modifiers include, without limitation, high impact polystyrene (HIPS), SEEPS, ethylene—methacrylate resins (EMA), styrene/butadiene block copolymers, ABS, copolymers of C₁-C₁₂-linear, branched or cyclic olefins, C₁-C₁₂-linear, branched or cyclic alkyl esters of (meth)acrylic acid, styrenic monomers, styrene/ethylene/butadiene/styrene, block copolymers, styrene/ethylene copolymers. The amount of impact modifier used is typically in the range of 0.5 to 25 wt. % of the polymer blend composition.

Suitable ultra-violet light (UV) stabilizers include, without limitation, 2-hydroxy-4-(octyloxy)-benzophenone, 2-hydroxy-4-(octyloxy)-phenylphenylmethanone, 2-(2′-hydroxy-3,5′-di-tetramethylphenyl)benzotriazole, and the family of UV stabilizers available under the trade TINUVIN® from Ciba Specialty Chemicals Co., Tarrytown, N.Y, in an amount of 0.1 to 2 wt. % of the polymer blend composition.

Suitable ultraviolet light absorbers, include without limitation, 2-(2-hydroxyphenyl)-2H-benzotriazoles, for example, known commercial hydroxyphenyl-2H-benzotriazoles and benzotriazoles hydroxybenzophenones, acrylates, malonates, sterically hindered amine stabilizers, sterically hindered amines substituted on the N-atom by a hydroxy-substituted alkoxy group, oxamides, tris-aryl-o-hydroxyphenyl-s-triazines, esters of substituted and unsubstituted benzoic acids, nickel compounds, and combinations thereof, in an amount of 0.1 to 2 wt. % of the polymer blend composition.

Suitable softening agents and plasticizers include, without limitation, cumarone-indene resin, d-limonene, terpene resins, and oils in an amount of about 2 parts by weight or less based on 100 parts by weight of the polymer blend composition.

In embodiments of the invention, the components of the polymer composition are combined into a homogenous mixture by any suitable technique, which can include without limitation, mixing extrusion (compounding) and milling. The polymer composition components are then blended in the form of granules or in powder form, according to the types of components, in a blender before plastification and homogenization. Blending may be effected in a discontinuous process working with batches or in a continuous process.

In embodiments of the invention, the components can be mixed, for example, in an internal mixer of Banbury type, in a single or twin-screw co-rotary or counter-rotary extruder, or in any other mixer capable of supplying sufficient energy to melt and fully homogenize the mixture.

In embodiments of the invention, the components of the polymer composition including any optional additives can be combined by melt blending.

In particular embodiments of the invention, production of the mixture resulting from the composition can be done by mixing extrusion (compounding) in a twin-screw extruder. Such a mixture must be a uniform and homogenous mixture.

In embodiments of the invention, the polymer composition is extruded into pellets obtained by cutting under cooling water; the pellets, which will be stored for subsequent conversion into items and parts. The conversion techniques used are those of plastics processing such as, in particular, injection if a cover is involved, and having very different wall thicknesses between the tear start zone and the support and fitting structural zone.

In embodiments of the invention, the polymer composition can be extruded directly into sheet, or film, or any article, without having to go through a pelletization step.

In some embodiments of the invention, the polymer composition film comprises one or more layers of a multilayer film structure.

In other embodiments of the present method, either method can include adding the polymer blend composition to a first extruder and then combining with the optional additives in a second extruder.

Regardless of which method is used, during the blending step, the second polyolefin and interpolymer resin particles are typically intimately mixed by high shear mixing to form the polymer blend composition where the mixture includes a continuous second polyolefin phase and an interpolymer resin particulate dispersed phase. The dispersed interpolymer resin particles are suspended or dispersed throughout the second polyolefin continuous phase. The manufacture of the dispersed interpolymer resin particulate phase within the second polyolefin continuous phase can require substantial mechanical input. Such input can be achieved using a variety of mixing means as indicated above.

In embodiments of the invention, blends of the interpolymer resin particles according to the invention and second polyolefin provide improved processing and physical properties compared to the second polyolefin alone.

As non-limiting examples, blown, cast, and extruded films of the interpolymer resin particle—second polyolefin blends, when compared to the second polyolefin alone demonstrate improved throughput and processability, improved Dart impact properties, improved modulus, improved tensile properties and improved elongation properties.

The films of the present invention can be produced by a variety of methods known to those skilled in the art. Non-limiting examples of suitable methods include extrusion, cast film techniques, blown film techniques and in the case of multilayer films, coextrusion, lamination by joining the various layers together with adhesives or with heat, and blown film processes. More particularly, suitable film processes include cast film, high-stalk blown extrusion, and in-pocket blown extrusion processes.

When the polymer blend composition is used in extrusion processing, particles of the polymer composition can be fed into an extruder, and then extruded as a single layer or co-extruded into multi-layer structures, e.g., sheet or film.

In embodiments of the invention, the film of the invention can be produced by extrusion through an annular die, blowing into a tubular film by forming a bubble which is collapsed between nip rollers after solidification. This film can then be slit, cut or converted (e.g., gusseted) as desired. Conventional film production techniques can be used in this regard. In many cases, the outer and core layer mixtures will be coextruded at a temperature in the range 160° to 240° C., and cooled by blowing gas (generally air) at a temperature of 10 to 50° C. to provide a frost line height of 1 or 2 to 8 times the diameter of the die. The blow up ratio can be in the range 1.5:1 to 4:1, in some cases from 2:1 to 4:1, and in other cases from 2.5:1 to 3:1.

Blown-films are produced by the extrusion of a molten resin through a ring shaped die. The resin is forced around a mandrel within the die, shaped and further extruded through the die in the form of a relatively thick tube. While molten, the relatively thick tube is expanded to produce a “bubble” of specified diameter and a thinner film (when compared to the relatively thick tube). This thinning is achieved with admittance of air up through the die and mandrel at start-up of the blown film production. The blown film is then drawn out by a set of nip rollers which also serve to flatten the “bubble”.

The process requires a ring of cooling air at the outlet of the mandrel, typically on the outer side of the bubble. This ring of air cools the “bubble” and allows easier flattening between the nip rolls.

The multilayer blown film structures can be produced in a similar manner but with multiple extruders and a single die, mandrel and cooling air ring. A bubble is produced and flattened downstream between nip rollers, as previously described.

Various take-off speeds are possible but, as a non-limiting example, can vary between 10 and 100 m/min, for the thickness of from 2 to 12 mils (50 to 300 μm) for three layer multilayer films structures. Those skilled in the art will understand that thicker gauges film will require a larger volume of cooling air for the higher extruder(s) output and faster take-off speeds.

Other parameters of importance are the BUR or Blow Up Ratio, which is the ratio of the “bubble” diameter of the blown film leaving the die versus the diameter of the die. Blown films have physical properties that vary depending on the orientation of the film produced. The film properties may vary in the MD or Machine Direction, versus the TD or Transverse Direction. The MD properties of the film are those measured with respect to the direction of the film out from the extruder. TD or Transverse Direction properties are those measured transverse to the MD and are associated with the width of the film structure. To minimize, differences in the MD and TD properties, blown film production is usually run at a BUR of between 2 and 2.5. At these ratios the physical properties in the MD and the TD directions are more balanced.

In embodiments of the invention, the film is made by extruding directly into sheet, or film, or any article.

As non-limiting examples, blown and extruded single films and multilayer films that include the interpolymer resin particle—polyolefin blend as a core layer, compared to the polyolefin alone as a core layer, demonstrate improved throughput and processability, improved Dart impact properties, improved modulus, improved tensile properties and improved elongation properties.

Cast film techniques can be used to make the present films. A non-limiting example of cast film techniques includes methods where the polymer melt from the extruder is fed into a wide flat die; the extrudate then comes out of the die as a thin, wide curtain of film and the molten curtain is cast directly into a quench tank or onto a chill roll. Often, a nip roll arrangement then pulls the film, which is latter wound into rolls.

The following examples are intended to aid in understanding the present invention, however, in no way, should these examples be interpreted as limiting the scope thereof.

### EXAMPLES

### Example 1

This Example 1 relates to styrene-polyethylene interpolymer resin particles comprised of 60% by weight polystyrene and 40% by weight of low-density polyethylene, based on the weight of the interpolymer resin particles.

A mixture of 520 pounds of de-ionized water, 9.6 pounds of tri-calcium phosphate as a suspending agent, and 27 grams of a strong anionic surfactant were charged to a polymerization reactor with the agitator running at 88 rpm to prepare an aqueous medium. The surfactant was Nacconol® 90 (Stephan Chemical Co.), which is sodium n-dodecyl benzene sulfonate. The aqueous medium was heated to about 91° C. and held for about 10 minutes. Then 112 pounds of low density polyethylene (LDPE) pellets (LA-0218-AF from NOVA Chemicals Inc.), each weighing about 20 milligrams, having a melt index of 2.1 g/10 minutes (190° C./2.16 kg), and a VICAT softening point of about 93° C. were added to the aqueous medium. This suspension of beads and water continued to be stirred at 88 rpm. The low temperature polystyrene initiators, i.e., 373 grams of benzoyl peroxide (BPO) (75% active) and 70 grams of tertiary butyl perbenzoate (TBP) were dissolved in 84 pounds of styrene monomer to prepare a monomer solution, and this mixture was pumped into the reactor over 200 minutes. A second batch of 84 pounds of pure styrene was then added to the reactor over 100 minutes at a temperature of 91° C. The reactor contents were held at 91° C. for an additional 90 minutes to allow the styrene to soak into and react within the polyethylene. Then the reactor contents were heated to 140° C. over 2 hours and held for an additional 4 hours to polymerize the remaining styrene into polystyrene within the polyethylene matrix.

After polymerization, the reactive mixture was cooled and hydrochloric acid was added to dissolve the suspending agents. The resin particles were then washed and dried.

The average gel content for two samples of the resin particles was 0.65 weight % based on the weight of the formed interpolymer resin particles. The melt index was 1.046 g/10 minutes (230° C15.0 kg).

### Example 2

This Example 2 relates to interpolymer styrene-polyethylene interpolymer resin particles comprised of 70% by weight polystyrene and 30% by weight low-density polyethylene, based on the weight of the interpolymer resin particles.

A mixture of 520 pounds of deionized water, 9.6 pounds of tri-calcium phosphate as a suspending agent, and 27 grams of a strong anionic surfactant (Nacconol® 90) were charged to a polymerization reactor with the agitator running at about 88 rpm to prepare an aqueous medium. The aqueous medium was heated to about 91° C. and held for about 10 minutes. Then 84 pounds of low-density polyethylene pellets (LA-0218-AF) were suspended in the aqueous medium. The suspension continued to be stirred at 88 rpm. The low temperature polystyrene initiators, i.e., 356 grams of benzoyl peroxide (BPO) and 66.8 grams of tertiary butyl perbenzoate (TBP) were dissolved in 98 pounds of styrene monomer to prepare a monomer solution, and this mixture was pumped into the reactor over 200 minutes. A second batch of 98 pounds of pure styrene was then added to the reactor over 100 minutes at a temperature of 91° C. The reactor contents were held at 91° C. for an additional 90 minutes to allow the styrene to soak into and react within the polyethylene. Then the reactor contents were heated to 140° C. over 2 hours and held at this temperature for an additional 4 hours to polymerize the remaining styrene into polystyrene within the polyethylene matrix.

After polymerization, the reactive mixture was cooled and hydrochloric acid was added to dissolve the suspending agents. The resin particles were then washed and dried.

The average gel content for two samples of resin particles was 0.45% by weight based on the weight of the particles. The melt index was 0.501 g/10 minutes (230° C./5.0 kg).

### Example 3

This Example 3 relates to styrene-polyethylene interpolymer resin particles comprised of 50% by weight polystyrene and 50% by weight low-density polyethylene, based on the weight of the interpolymer resin particles.

A mixture of 520 pounds of de-ionized water, 9.6 pounds of tri-calcium phosphate as a suspending agent, and 27 grams of a strong anionic surfactant (Nacconol® 90) were charged to a polymerization reactor with the agitator running at about 88 rpm to prepare an aqueous medium. The aqueous medium was heated to about 91° C. and held for about 10 minutes. Then 140 pounds of low-density polyethylene pellets (LA-0218-AF) were suspended in the aqueous medium. The suspension continued to be stirred at 88 rpm. The low temperature polystyrene initiators, i.e., 350 grams of benzoyl peroxide (BPO) and 65.63 grams of tertiary butyl perbenzoate (TBP), were dissolved in 70 pounds of styrene monomer to prepare a monomer solution, and this mixture was pumped into the reactor over 200 minutes. A second batch of 70 pounds of pure styrene was then added to the reactor over 100 minutes at a temperature of 91° C. The reactor contents were held at 91° C. for an additional 90 minutes to allow the styrene to soak into and react within the polyethylene. Then the reactor contents were heated to 140° C. over 2 hours and held for an additional 4 hours to polymerize the remaining styrene into polystyrene within the polyethylene matrix. After polymerization, the reactive mixture was cooled and hydrochloric acid was added to dissolve the suspending agents. The resin particles were then washed and dried.

The average gel content for two samples of resin particles was 0.69% by weight based on the weight of the formed interpolymer resin particles. The melt index was 1.022 g/10 minutes (230° C./5.0 kg).

### Example 4

This Example 4 is similar to Example 1 in that a styrene-polyethylene interpolymer with 60% by to weight polystyrene and 40% by weight low density polyethylene based on the weight of the interpolymer particles was produced. In this Example 4, however, a chain transfer agent was used in an attempt to increase the melt flow rate of the interpolymer resin.

Alpha methyl styrene dimer (a chain transfer agent) in an amount of 163 grams, i.e., about 0.20 parts per hundred of styrene was added to the suspension with the benzoyl peroxide (BPO) and the tertiary butyl perbenzoate (TBP).

The average gel content for two samples of the resin particles was 1.01% by weight based on the weight of the formed interpolymer resin particles. The melt index was 2.688 g/10 minutes (230° C./5.0 kg). These results demonstrate that when using a chain transfer agent without a cross-linking agent the melt index was increased compared to Example 1.

### Example 5

In this Example 5, interpolymer resin particles were produced comprising 60% by weight polystyrene and 40% by weight ethylene vinyl acetate copolymer (EVA), based on the weight of the resin particles. No high temperature cross-linking agent, i.e., dicumyl peroxide initiator was added.

A mixture of 380 pounds of de-ionized water, 13 pounds of tri-calcium phosphate as a suspending agent, and 8.6 grams of Nacconol® 90 anionic surfactant were charged to a polymerization reactor with the agitator running at about 102 rpm to prepare an aqueous medium.

The aqueous medium was heated to about 60° C. and held for about 30 minutes. Then 125 pounds of a low-density polyethylene vinyl acetate (EVA) pellets containing 4.5% by weight vinyl acetate and 95.5% by weight ethylene (NA 480 from Equistar Chemicals, LP, Houston, Tex.) and having a density of about 0.923 g/cc and a melt index of 0.25 g/10 minutes (190° C./2.16 kg) were suspended in the aqueous medium. The reactor temperature was increased to 85° C. The low temperature polystyrene initiators, i.e., 246 grams of benzoyl peroxide (BPO) and 30 grams of tertiary butyl perbenzoate (TBP), were dissolved in 22.6 pounds of styrene monomer to prepare a monomer solution, and this mixture was pumped into the reactor over 96 minutes. A second batch of 146 pounds of pure styrene and 5.0 lbs of butyl acrylate was then added to the reactor over 215 minutes. Then the reactor contents were heated and held at 140° C. for over 8 hours to finish the polymerization of styrene within the polyethylene matrix.

After polymerization was completed, the reactive mixture was cooled and removed to a wash kettle where muriatic acid (HCl) was added to dissolve the suspending agents from the pellet surfaces. The pellets were then washed and dried.

The average gel content for two samples of the resin pellets was 0.46 weight % based on the weight of the formed interpolymer resin particles. The melt index of the pellets was 0.21 g/10 minutes (230° C./5.0 kg).

### Example 6

This Example 6 relates to interpolymer resin particles comprising 70% by weight polystyrene based on the weight of the interpolymer resin particles, and 30% by weight of ethylene vinyl acetate copolymer (EVA). The process for making the particles was similar to that for Example 5. The low-density polyethylene vinyl acetate (EVA) used in Example 5 was the same as used in Example 6.

A mixture of 411 pounds of de-ionized water, 9.8 pounds of tri-calcium phosphate as a suspending agent, and 6.5 grams of anionic surfactant (Nacconol® 90) were charged to a polymerization reactor with the agitator running at about 102 rpm to prepare an aqueous medium. The aqueous medium was heated to about 60° C. and held for about 30 minutes. Then 87 pounds of the low-density ethylene vinyl acetate pellets were suspended in the aqueous medium. The reactor temperature was increased to 85° C. The low temperature polystyrene initiators, i.e., 246 grams of benzoyl peroxide (BPO) and 30 grams of tertiary butyl perbenzoate (TBP), were dissolved in 22.6 pounds of styrene monomer to prepare a monomer solution, and this mixture was pumped into the reactor over 96 minutes. A second batch of 146 pounds of pure styrene and 5.0 lbs of butyl acrylate was then added to the reactor over a period of 215 minutes. Then the reactor contents were heated and held at 140° C. for over 8 hours to finish the polymerization of styrene within the polyethylene matrix.

After polymerization was completed, the reactive mixture was cooled and removed to a wash kettle where muriatic acid (HCl) was added to dissolve the suspending agents from the pellet surfaces. The pellets were then washed and dried.

The average gel content for two samples of the resin pellets was 0.32% by weight based on the weight of the formed interpolymer resin particles. The melt index of the pellets was 0.25 g/10 minutes (230° C./5.0 kg).

Examples 7 and 8 below show that the use of dicumyl peroxide for viscbreaking purposes increases the melt index of the resin.

### Example 7

This Example 7 relates to interpolymer resin particles comprising 60% by weight polystyrene based on the weight of the interpolymer resin particles, and 40% by weight of polypropylene. Dicumyl peroxide was added to viscbreak the polypropylene.

A mixture of 520 pounds of deionized water, 9.6 pounds of tri-calcium phosphate as a suspending agent, and 27 grams of Nacconol 90 were charged to a polymerization reactor with the agitator running at about 88 rpm to prepare an aqueous medium. The aqueous medium was heated to about 91° C. and held for about 10 minutes. Then 112 pounds of polypropylene pellets (Huntsman P5M4K-046), each weighing about 20 milligrams and having a MI of 25.5 g/10 minutes (230° C./5.0 kg) were suspended in the aqueous medium. The suspension continued to be stirred at 88 rpm. The low temperature polystyrene initiators, i.e., 473 grams of benzoyl peroxide (BPO) and 145 grams of tertiary butyl perbenzoate (TBP), and 173 grams of dicumyl peroxide (for viscbreaking the polypropylene) were dissolved in 84 pounds of styrene monomer to prepare a monomer solution, and this mixture was pumped into the reactor over 200 minutes. A second batch of 84 pounds of pure styrene was then added to the reactor over 100 minutes at a temperature of 91° C. The reactor contents were held at 91° C. for an additional 90 minutes to allow the styrene to soak into and react with the polypropylene. Then the reactor contents were heated to 140° C. for over 2 hours and held for an additional 4 hours to polymerize the styrene into polystyrene within the matrix of the polyethylene.

After polymerization, the reactive mixture was cooled and removed, and an acid was added to dissolve the suspending agents.

The average gel content for two samples of the resin particles was 0.47% by weight based on the weight of the formed interpolymer resin particles. The melt index was 32.61 g/10 minutes (230° C./5.0 kg).

### Example 8

This Example 8 relates to interpolymer resin particles comprising 70% by weight polystyrene based on the weight of the interpolymer resin particles, and 30% by weight of polypropylene. Dicumyl peroxide was added to the formulation to viscbreak the polypropylene. The process for producing the interpolymer resins is similar to Example 7.

A mixture of 520 pounds of de-ionized water, 9.6 pounds of tri-calcium phosphate as a suspending agent, and 27 grams of an anionic surfactant (Nacconol 90) were charged to a polymerization reactor with the agitator running at about 88 rpm to prepare an aqueous medium. The aqueous medium was heated to about 91° C. and held for about 10 minutes. Then 112 pounds of polypropylene pellets (Huntsman P5M4K-046) each weighing about 20 milligrams and having a MI of 25.5 g/10 minutes (230° C./5.0 kg) were suspended in the aqueous medium. The suspension continued to be stirred at 88 rpm. The low temperature polystyrene initiators, i.e., 475 grams of benzoyl peroxide (BPO) (for improved grafting) and 145 grams of tertiary butyl perbenzoate (TBP) (for reducing the styrene residuals), and 173 grams of dicumyl peroxide for viscbreaking the polypropylene were dissolved in 98 pounds of styrene monomer to prepare a monomer solution, and this mixture was pumped into the reactor over 200 minutes. A second batch of 98 pounds of pure styrene was then added to the reactor over 100 minutes at a temperature of 91° C. The reactor contents were held at 91° C. for an additional 90 minutes to allow the styrene to soak into and react within the polypropylene. Then the reactor contents were heated to 140° C. for over 2 hours and held for an additional 4 hours to polymerize the styrene into polystyrene within the matrix of the polypropylene.

After polymerization was completed, the reactive mixture was cooled and removed, and an acid was added to dissolve the suspending agents.

The average gel content for two samples was 0.41% by weight based on the weight of the formed interpolymer resin particles. The melt index was 21.92 g/10 minutes (230° C./5.0 kg).

The particles produced in Examples 1-8 were oven dried at 49° C. and then molded into plaques using an Engel Model 80 injection-molding machine. The mechanical and physical properties were measured and tested according to the standards set up by ASTM. These properties appear in the table below.

As stated herein above, the flexural and tensile properties of the articles formed from the interpolymer resin particles of the invention have values that range between those values for articles made solely from polystyrene and those values for articles made solely from low-density polyethylene, while the thermal and impact properties of the articles made from the interpolymer resin particles approach that of pure polystyrene.

| | | | | | | | Comp. | Comp. |
|---|---|---|---|---|---|---|---|---|
| Property | Example 1 | Example 2 | Example 3 | Example 4 | Example 5 | Example 6 | Example 7 | Example 8 |
| Flex Modulus | 200.52 | 256.47 | 170.46 | 222.63 | 211.19 | 269.25 | 303.89 | 348.76 |
| (KSI) | | | | | | | | |
| Flex | 6.67 | 8.34 | 5.63 | 7.55 | 6.78 | NA | 9.14 | 9.08 |
| Stress@<5% | | | | | | | | |
| (KSI) | | | | | | | | |
| Strain at | 2.14 | 4.43 | 3.00 | 5.48 | 3.17 | 3.30 | 2.51 | 2.07 |
| Break(Auto) % | | | | | | | | |
| Stress at | 3.69 | 5.09 | 3.32 | 4.54 | 4.97 | 4.91 | 4.88 | 5.43 |
| Break(Auto)(KSI) | | | | | | | | |
| YOUNGS | NA | 281.92 | NA | 242.02 | 279.95 | 281.52 | 325.65 | 366.07 |
| Modulus | | | | | | | | |
| (Auto)(KSI) | | | | | | | | |
| IZOD Impact | 0.404 | 0.233 | 0.490 | 0.446 | 0.430 | 0.338 | 0.174 | 0.150 |
| Mean | | | | | | | | |
| DYNATUP-Total | 0.43 | 0.47 | 0.55 | 0.50 | NA | NA | 0.53 | 0.42 |
| Energy (ft-lbs) | | | | | | | | |
| MI(230° C./5.0 kg) | 1.046 | 0.501 | 1.022 | 2.688 | 0.21 | 0.25 | 32.61 | 21.92 |
| VICAT-Mean | 101.00 | 104.8 | 99.00 | 101.6 | NA | NA | 110.2 | 108.7 |
| (° C.) | | | | | | | | |
| Gel | 0.65 | 0.45 | 0.69 | 1.01 | 0.46 | 0.32 | 0.47 | 0.41 |
| wt % (Average) | | | | | | | | |

### Example 9

A blend containing 98 wt. % FPs 117C (linear low density polyethylene available from NOVA Chemicals) and 2 wt. % of an interpolymer of 70 wt. % ethylene-vinyl acetate copolymer (EVA)/30 wt. % polystyrene (prepared as described in Example 1) was prepared by compounding on a Leistritz twin screw extruder (co-rotating, inter-meshing, 35/1-L/D). The blend was processed at temperatures between 190 and 230° C. Vacuum was pulled from one or more of the ports to extract unnecessary volatiles or by-products from the mixtures. The blend was strand cut/pelletized after being cooled with flowing tap water.

The films of the polyethylene alone (PE) and blend (Blend) were produced using a Macro Engineering and Technology blown film line under the following conditions:

Blow Up Ratio (BUR)=2.5:1

Die Gap: 50 mil

Dual lip air ring

Film Gauge=1 mil

Melt Temperature=211° C.

Line Speed=71.8 ft/min.

| | Max | | | | |
|---|---|---|---|---|---|
| | Output | Melt Temp | Current | Screw Speed | Air Ring Pressure |
| Resin | (lb/hr) | (° C.) | (amps) | (rpm) | (inches of water) |
| PE | 398 | 234 | 16.3 | 58 | 12.5 |
| Blend | 439 | 233 | 16.2 | 64 | 16 |

The processing improvement using the blend according to the invention provided a nine percent improved output compared with the polyethylene alone. Qualitative antiblock properties were also observed for the blend.

### Example 10

A blend of 90 wt. % FP 120C (linear low density polyethylene available from NOVA Chemicals) and 10 wt. % of the interpolymer used in Example 12 was prepared as described in Example 12 (90/10 blend). Film samples of the polyethylene (PE) alone and the blend were prepared as described in Example 9. Comparative physical properties of the sheets are shown in the following table.

| | | 90/10 | Improvement |
|---|---|---|---|
| | PE | Blend | (%) |
| Dart Impact (g/ml) | 282 | 421 | 49 |
| 1% Sec Modulus - MD (MPa) | 176 | 278 | 58 |
| 1% Sec Modulus - TD (MPa) | 209 | 306 | 46 |
| Tensile Break Str - MD (MPa) | 34.4 | 45.6 | 33 |
| Tensile Break Str - TD (MPa) | 33.0 | 40.2 | 22 |
| Elongation at Break - MD (%) | 445 | 588 | 32 |
| Elongation at Break - TD (%) | 693 | 774 | 12 |
| Tensile Yield Str - MD (MPa) | 10.7 | 12.8 | 20 |
| Tensile Yield Str - TD (MPa) | 9.9 | 11.4 | 15 |
| Tensile Elongation at Yield - MD | 16 | 16 | 0 |
| (%) | | | |
| Tensile Elongation at Yield - TD | 20 | 15 | −25 |
| (%) | | | |

The blend film demonstrated a 50% modulus increase in both the machine and transverse directions, almost 50% increase in Dart impact, and 30% improvement in tensile and elongation properties over the film that was 100% polyethylene.

### Example 11

A/B/A film structures were produced as described in Example 9 using the indicated Blow-up Ratio and film thickness. The core layer (B) made up 60 wt. % of the overall film composition, and the (A) layers were 20 wt. % each. They (A) layers were NOVAPOL® TD-9022-C (9022) polyethylene resin (ethylene-hexane copolymer), which had a Melt Index of 0.8 g/10 min. (ASTM D1238, 190° C./2.16 Kg) and density of 0.916 g/cm³ (ASTM D 792). The core layer (B) was as described in the table below using the interpolymer described in Example 9 (interpolymer). All percentages are expressed in wt. %.

| | | | 98% 9022 | | 98% 9022 | |
|---|---|---|---|---|---|---|
| | | | 2% | | 2% | |
| Core Layer (B) | 100% 9022 | | interpolymer | | interpolymer | |
| Blow-up Ratio | 3:1 | | 3:1 | | 1.7:1 | |
| Film thickness | 3 | mil | 3 | mil | 3 | mil |
| Film density | 0.9180 | g/cm³ | 0.9178 | g/cm³ | 0.9184 | g/cm³ |

| | | | |
|---|---|---|---|
| Dart Impact (g) | 1240 | 1258 | 922 |
| 1% Sec Modulus - MD | 156 | 167 | 171 |
| (MPa) | | | |
| 1% Sec Modulus - TD | 167 | 173 | 182 |
| (MPa) | | | |

A slight increase in modulus of the blown film having a core layer (B) containing the present interpolymer compared to the pure polyethylene film. This observation indicates that low loadings of interpolymer can increase the physical properties without harming other physical properties.

In addition, these results exhibit the importance of the blown film processing conditions, as the interpolymer containing blown film processed at a 3.0:1 blow up ratio showed improved physical properties compared to the same polystyrene/polyethylene interpolymer containing blown film processed at a 1.7:1 blow up ratio.

The following table indicates that even low loadings of the present interpolymer in core layer (B) of a three-layer film can significantly increase certain physical characteristics of blown films. In this particular case, creep was measured on the 3.0:1 blow up ratio films composed of pure polyethylene and the sample using core layer (B) containing the present interpolymer. The data shows loadings as low as 2% in a core layer of an A/B/A blown film structure (20/60/20) can provide increased creep resistance, or lower elongation under constant load.

| | |
|---|---|
| | 98% 9022/2% |
| 100% 9022 | interpolymer |

| Time | MD | TD | MD | TD |
|---|---|---|---|---|
| (Hours) | (%) | (%) | (%) | (%) |
| 0 | 0 | 0 | 0 | 0 |
| 0.001 | 5 | 5 | 3 | 3 |
| 0.08 | 6 | 6 | 3 | 3 |
| 0.5 | 8 | 10 | 5 | 6 |
| 1 | 10 | 10 | 5 | 6 |
| 2 | 10 | 10 | 5 | 6 |
| 4 | 10 | 11 | 5 | 8 |
| 6 | 13 | 13 | 6 | 10 |
| 24 | 13 | 13 | 6 | 10 |
| 48 | 13 | 14 | 6 | 11 |

### Example 12

A/B/A film structures were produced on a Gloucester cast film line equipped with 2.5″ extruders. The core layer (B) comprised of 80% of the overall film composition, while film thickness was 0.8 mil. Die lips gap and line speed were set at 20 mils and 800 feet per minute, respectively. The (A) layers was SCLAIR® FG220-A (220) polyethylene resin (ethylene-octene copolymer), which had a Melt Index of 2.3 g/10 min. (ASTM D1238, 190° C./2.16 Kg) and density of 0.920 g/cm³ (ASTM D 792). The core layer (B) was as described in the table below using the interpolymer described in Example 6 (ex-int). All percentages are expressed in wt. %.

| | | 90% 220 | 80% 220 | 60% 220 |
|---|---|---|---|---|
| | | 10% | 20% | 40% |
| Core Layer (B) | 100% 220 | ex-int | ex-int | ex-int |
| Density Column (g/cm³) | 0.9151 | 0.9201 | 0.9230 | 0.9337 |
| Dart Impact (g/mil) | 129 | 183 | 186 | 125 |
| 1% Secant Modulus MD | 131 | 280 | 380 | 672 |
| (MPa) | | | | |
| 2% Secant Modulus MD | 122 | 257 | 359 | 626 |
| (MPa) | | | | |
| 1% Secant Modulus TD | 158 | 185 | 217 | 279 |
| (MPa) | | | | |
| 2% Secant Modulus TD | 135 | 171 | 194 | 253 |
| (MPa) | | | | |
| Tensile Elongation | 396 | 506 | 250 | 108 |
| MD (%) | | | | |
| Tensile Elongation | 687 | 647 | 578 | 461 |
| TD (%) | | | | |
| Tensile Yield Strength | 10 | 12 | 16 | 20 |
| MD (MPa) | | | | |
| Tensile Yield Strength | 9 | 11 | 11 | 13 |
| TD (MPa) | | | | |
| Elmendorf Tear MD (G) | 247 | 91 | 54 | 14 |
| Elmendorf Tear TD (G) | 484 | 356 | 271 | 23 |

As indicated in the table, the density of the interpolymer containing films increased with increased interpolymer loadings. Increases in modulus are also observed with increased interpolymer loadings. Films with greater moduli offer the advantage of increased stiffness.

Dart impact properties increased up to 20% interpolymer loading and were lower at 40% interpolymer loading. Film stiffness doubled with 10% interpolymer loading. Films with greater impact properties offer the advantage of increased toughness.

The interpolymer containing films showed lower tear properties. This indicates that films containing the interpolymers may have increased peelability properties.

In general, the results indicate that a converter would be able to tailor the tensile and elongational properties of polyethylene-based cast films by incorporating specific amounts of the present interpolymer.

### Example 13

A/B/A film structures were produced on a Gloucester cast film line equipped with 2.5″ extruders. The core layer (B) comprised of 80% of the overall film composition, while film thickness was 0.8 mil. Die lips gap and line speed were set at 20 mils and 800 feet per minute, respectively. The (A) layers was SCLAIR® FG120-A (120) polyethylene resin (ethylene-octene copolymer), which had a Melt Index of 1.0 g/10 min. (ASTM D1238, 190° C./2.16 Kg) and density of 0.920 g/cm³ (ASTM D 792). The core layer (B) was as described in the table below using the interpolymer described in Example 6 (ex-int). All percentages are expressed in wt. %.

| | | 90% 120 | 80% 120 |
|---|---|---|---|
| Core Layer (B) | 100% 120 | 10% ex-int | 20% ex-int |
| Density Column (g/cm³) | 0.9147 | 0.9210 | 0.9225 |
| Dart Impact (g/mil) | 246 | 328 | 221 |
| 1% Secant Modulus MD (MPa) | 117 | 260 | 399 |
| 2% Secant Modulus MD (MPa) | 110 | 248 | 376 |
| 1% Secant Modulus TD (MPa) | 148 | 185 | 226 |
| 2% Secant Modulus TD (MPa) | 131 | 167 | 201 |
| Tensile Elongation MD (%) | 340 | 353 | 239 |
| Tensile Elongation TD (%) | 669 | 626 | 606 |
| Tensile Yield Strength MD | 8 | 12 | 15 |
| (MPa) | | | |
| Tensile Yield Strength TD | 8 | 10 | 11 |
| (MPa) | | | |
| Elmendorf Tear MD (G) | 349 | 64 | 38 |
| Elmendorf Tear TD (G) | 589 | 463 | 435 |

As indicated in the table, the density of the interpolymer containing films increased with increased interpolymer loadings. Increases in modulus are also observed with increased interpolymer loadings. Films with greater moduli offer the advantage of increased stiffness.

Dart impact properties increased up to 10% interpolymer loading. Film stiffness doubled with 10% interpolymer loading. Films with greater impact properties offer the advantage of increased toughness.

The interpolymer containing films showed lower tear properties. This indicates that films containing the interpolymers may have increased peelability properties.

In general, the results indicate that a converter would be able to tailor the stiffness and toughness properties of polyethylene-based cast films by incorporating specific amounts of the present interpolymer.

### Example 14

A/B/A film structures were produced on a Gloucester cast film line equipped with 2.5″ extruders. The core layer (B) comprised of 80% of the overall film composition, while film thickness was 0.8 mil. Die lips gap and line speed were set at 20 mils and 800 feet per minute, respectively. Extruder output temperature was between 243° C. and 249° C. was passed into an extrusion die head to form a continuous multi-layer sheet structure.

The (A) layers were SCLAIR® FG220-A resin (NOVA Chemicals) polyethylene resin (ethylene-octene copolymer), which had a Melt Index of 2.3 g/10 min. (ASTM D1238, 190° C./2.16 Kg) and density of 0.920 g/cm³ (ASTM D 792). The core layer (B) was as described in the table below using the interpolymer resin particle described in Example 2 (70% polyethylene-30% polystyrene) [ex-100]. All percentages at expressed in wt. %.

| | | | | 90% | 80% | 60% |
|---|---|---|---|---|---|---|
| | | 98% | 95% | FG220 | FG220 | FG220 |
| | 100% | FG220 | FG220 | 10% ex- | 20% ex- | 40% ex- |
| Core Layer (B) | FG220 | 2% ex-100 | 5% ex-100 | 100 | 100 | 100 |
| Dart Impact (g/mil) | 137 | 238 | 208 | 192 | 186 | 125 |
| 1% Secant Modulus MD | 128.5 | 170.0 | 181.9 | 259.9 | 379.9 | 671.8 |
| (MPa) | | | | | | |
| 2% Secant Modulus MD | 120.5 | 161.0 | 169.0 | 239.9 | 358.9 | 625.8 |
| (MPa) | | | | | | |
| 1% Secant Modulus TD | 156.5 | 181.9 | 196.9 | 194.9 | 216.9 | 278.9 |
| (MPa) | | | | | | |
| 2% Secant Modulus TD | 135.5 | 162.0 | 175.9 | 178.4 | 193.9 | 252.9 |
| (MPa) | | | | | | |
| Elmendorf Tear MD (g/mil) | 250 | 311 | 306 | 158 | 68 | 18 |
| Elmendorf Tear TD (g/mil) | 545 | 546 | 500 | 431 | 339 | 29 |
| Tensile Elongation MD (%) | 416 | 495 | 495 | 476 | 250 | 108 |
| Tensile Elongation TD (%) | 697 | 734 | 734 | 664 | 578 | 461 |
| Tensile Yield Strength MD | 9.75 | 9.90 | 10.4 | 11.6 | 18.1 | 20.0 |
| (MPa) | | | | | | |
| Tensile Yield Strength TD | 8.90 | 10.6 | 10.6 | 11.0 | 11.0 | 13.0 |
| (MPa) | | | | | | |

As indicated in the table, increases in modulus are observed with increased interpolymer resin particle loadings. Films with greater moduli offer the advantage of increased stiffness.

Dart impact properties increased, compared to the control, at up to 20% interpolymer resin particle loading. Film stiffness doubled with 10% interpolymer resin particle loading. Elmendorf Tear remained relatively constant up to about 10% interpolymer resin particle loading. Films with greater impact properties offer the advantage of increased toughness.

In general, the results indicate that a converter would be able to tailor the tensile and elongational properties of polyethylene-based cast films by incorporating specific amounts of the present interpolymer resin particles.

### Example 15

A/B/A film structures were produced on a Gloucester cast film line equipped with 2.5″ extruders. The core layer (B) comprised of 80% of the overall film composition, while film thickness was 0.8 mil. Die lips gap and line speed were set at 20 mils and 800 feet per minute, respectively. Extruder output temperature was between 470° F. and 480° F. was passed into an extrusion die head to form a continuous multi-layer sheet structure.

The (A) layers were SCLAIR® FG220-A resin (NOVA Chemicals) polyethylene resin (ethylene-octene copolymer), which had a Melt Index of 2.3 g/10 min. (ASTM D1238, 190° C./2.16 Kg) and density of 0.920 g/cm³ (ASTM D 792). The core layer (B) was as described in the table below using the interpolymer resin particle described in Example 6 (70% polyethylene-30% 96.7%/3.3% styrene-butyl acrylate copolymer) [ex-97/3]. All percentages at expressed in wt. %.

| | | 98% | 95% | 92% | 90% | |
|---|---|---|---|---|---|---|
| | | FG220 | FG220 | FG220 | FG220 | 88% |
| | 100% | 2% ex- | 5% ex- | 8% ex- | 10% ex- | FG220 |
| Core Layer (B) | FG220 | 97/3 | 97/3 | 97/3 | 97/3 | 12% 97/3 |
| Dart Impact (g/mil) | 137 | 201 | 202 | 240 | 187 | 184 |
| 1% Secant Modulus MD (MPa) | 128.5 | 166.0 | 223.9 | 219.9 | 249.9 | 272.9 |
| 2% Secant Modulus MD (MPa) | 120.5 | 153.0 | 207.9 | 206.9 | 235.9 | 251.9 |
| 1% Secant Modulus TD (MPa) | 156.5 | 192.9 | 178.9 | 202.9 | 201.4 | 202.9 |
| 2% Secant Modulus TD (MPa) | 135.5 | 172.9 | 165.0 | 175.9 | 176.4 | 183.9 |
| Elmendorf Tear MD (g/mil) | 250 | 318 | 285 | 349 | 275 | 225 |
| Elmendorf Tear TD (g/mil) | 545 | 521 | 525 | 531 | 486 | 440 |
| Tensile Elongation MD (%) | 416 | 538 | 527 | 521 | 494 | 424 |
| Tensile Elongation TD (%) | 697 | 713 | 658 | 712 | 700 | 704 |
| Tensile Yield Strength MD (MPa) | 9.75 | 11.2 | 11.6 | 11.2 | 11.6 | 12.0 |
| Tensile Yield Strength TD (MPa) | 8.90 | 10.4 | 11.1 | 10.2 | 10.0 | 11.0 |

As indicated in the table, increases in modulus are observed with increased interpolymer resin particle loadings. Films with greater moduli offer the advantage of increased stiffness.

Dart impact properties increased, compared to the control through 12% interpolymer resin particle loading. Film stiffness significantly increased from 2% to 12% interpolymer resin particle loading. Elmendorf Tear remained relatively constant up to 12% interpolymer resin particle loading. Films with greater impact properties offer the advantage of increased toughness.

In general, the results indicate that a converter would be able to tailor the tensile and elongational properties of polyethylene-based cast films by incorporating specific amounts of the present interpolymer resin particles.

### Example 16

A/B/A film structures were produced on a Gloucester cast film line equipped with 2.5″ extruders. The core layer (B) comprised of 80% of the overall film composition, while film thickness was 0.8 mil. Die lips gap and line speed were set at 20 mils and 800 feet per minute, respectively. Extruder output temperature was between 243° C. and 249° C. was passed into an extrusion die head to form a continuous multi-layer sheet structure.

The (A) layers were SCLAIR® FG220-A resin (NOVA Chemicals) polyethylene resin (ethylene-octene copolymer), which had a Melt Index of 2.3 g/10 min. (ASTM D1238, 190° C./2.16 Kg) and density of 0.920 g/cm³ (ASTM D 792). The core layer (B) was as described in the table below using the interpolymer resin particle described in Example 6, except that the weight ratio of styrene to butyl acrylate used to make the interpolymer resin particles was 90/10 (70% polyethylene-30% 90%/10% styrene-butyl acrylate copolymer) [ex-90/10]. All percentages at expressed in wt. %.

| | | | | | 88% FG220 |
|---|---|---|---|---|---|
| | 100% | 98% FG220 | 95% FG220 | 92% FG220 | 12% ex- |
| Core Layer (B) | FG220 | 2% ex-90/10 | 5% ex-90/10 | 8% ex-90/10 | 90/10 |
| Dart Impact (g/mil) | 137 | 148 | 190 | 251 | 212 |
| 1% Secant Modulus MD (MPa) | 128.5 | 170.0 | 201.9 | 206.9 | 231.9 |
| 2% Secant Modulus MD (MPa) | 120.5 | 155.0 | 186.9 | 191.9 | 216.9 |
| 1% Secant Modulus TD (MPa) | 156.5 | 158.0 | 178.9 | 177.9 | 184.9 |
| 2% Secant Modulus TD (MPa) | 135.5 | 141.0 | 157.0 | 157.0 | 165.0 |
| Elmendorf Tear MD (g/mil) | 250 | 280 | 302 | 368 | 346 |
| Elmendorf Tear TD (g/mil) | 545 | 570 | 528 | 516 | 531 |
| Tensile Elongation MD (%) | 416 | 480 | 471 | 492 | 492 |
| Tensile Elongation TD (%) | 697 | 674 | 672 | 688 | 649 |
| Tensile Yield Strength MD (MPa) | 9.75 | 9.80 | 10.8 | 10.4 | 11.0 |
| Tensile Yield Strength TD (MPa) | 8.90 | 8.7 | 8.8 | 9.4 | 9.8 |

As indicated in the table, increases in modulus are observed with increased interpolymer resin particle loadings. Films with greater moduli offer the advantage of increased stiffness.

Dart impact properties increased, compared to the control through 12% interpolymer resin particle loading. Film stiffness significantly increased from 2% to 12% interpolymer resin particle loading. Elmendorf Tear remained relatively constant up to 12% interpolymer resin particle loading. Films with greater impact properties offer the advantage of increased toughness.

In general, the results indicate that a converter would be able to tailor the tensile and elongational properties of polyethylene-based cast films by incorporating specific amounts of the present interpolymer resin particles.

### Example 17

A/B/A film structures were produced on a Gloucester cast film line equipped with 2.5″ extruders. The core layer (B) comprised of 80% of the overall film composition, while film thickness was 0.8 mil. Die lips gap and line speed were set at 20 mils and 800 feet per minute, respectively. Extruder output temperature was between 243° C. and 249° C. was passed into an extrusion die head to form a continuous multi-layer sheet structure.

The (A) layers were SURPASS® FPs317-A resin (NOVA Chemicals) polyethylene resin (ethylene-octene copolymer), which had a Melt Index of 4.0 g/10 min. (ASTM D1238, 190° C./2.16 Kg) and density of 0.917 g/cm³ (ASTM D 792). The core layer (B) was as described in the table below using the interpolymer resin particle described in Example 2 (70% polyethylene-30% polystyrene) [ex-100] with one exception. A master batch was prepared by mixing interpolymer resin particles ex-100 was into SURPASS FPs317-A resin at an 80/20 FPs317/ex-90/10 weight ratio and then mixed into additional SURPASS FPs317-A resin to arrive at the core layer (B) composition in the table below where all percentages at expressed in wt. %.

| | | 90% | 80% |
|---|---|---|---|
| | 100% | FPs317 | FPs317 |
| Core Layer (B) | FPs317 | 10% ex-100 | 20% ex-100 |
| Dart Impact (g/mil) | 183 | 305 | 296 |
| 1% Secant Modulus MD (MPa) | 134.0 | 146.0 | 163.0 |
| 2% Secant Modulus MD (MPa) | 125.0 | 134.0 | 153.0 |
| 1% Secant Modulus TD (MPa) | 146.0 | 143.0 | 153.0 |
| 2% Secant Modulus TD (MPa) | 132.0 | 129.0 | 141.0 |
| Elmendorf Tear MD (g/mil) | 371 | 428 | 377 |
| Elmendorf Tear TD (g/mil) | 502 | 510 | 467 |
| Tensile Elongation MD (%) | 577 | 589 | 538 |
| Tensile Elongation TD (%) | 708 | 699 | 742 |
| Tensile Yield Strength MD (MPa) | 8.6 | 9.0 | 9.6 |
| Tensile Yield Strength TD (MPa) | 8.4 | 8.3 | 9.5 |

As indicated in the table, increases in modulus are observed with increased interpolymer resin particle loadings up to 20%. Films with greater moduli offer the advantage of increased stiffness.

Dart impact properties increased, compared to the control, when interpolymer resin particles were included in the core (B) layer. Elmendorf Tear remained relatively constant up to about 10% to 20% interpolymer resin particle loading. Films with greater impact properties offer the advantage of increased toughness.

In general, the results indicate that a converter would be able to tailor the tensile and elongational properties of polyethylene-based cast films by incorporating specific amounts of the present interpolymer resin particles.

While the present invention has been particularly set forth in terms of specific embodiments thereof, it will be understood in view of the instant disclosure that numerous variations upon the invention are now enabled yet reside within the scope of the invention. Accordingly, the invention is to be broadly construed and limited only by the scope and spirit of the claims now appended hereto.

What is claimed is:

1. A method of improving the physical properties of a polyolefin film comprising:
providing interpolymer resin particles comprising a styrenic polymer intercalated within a first polyolefin, wherein the first polyolefin is present at from about 20% to about 80% by weight based on the weight of the particles, and the styrenic polymer is present at from about 20% to about 80% by weight based on the weight of the particles;
forming a blend composition by blending from about 0.1 to about 25 percent by weight based on the weight of the blend composition of interpolymer resin particles into a second polyolefin; and
forming a film from the blend composition.

2. The method according to claim 1, wherein the blend comprises from about 0.25 to about 10 percent by weight of the interpolymer resin particles, and from about 90 to about 99.75 percent by weight of at least one second polyolefin.

3. The method according to claim 1, wherein the film has a higher tensile yield strength than a film of the second polyolefin that does not include the interpolymer resin particles.

4. The method according to claim 1, wherein the polyolefin of the interpolymer resin particles has a VICAT softening temperature greater than 60° C. and a melt index of from about 0.3 to about 15 g/10 minutes (190° C./2.16 kg).

5. The method according to claim 1, wherein the first polyolefin in the interpolymer resin particles is not cross-linked.

6. The method according to claim 1, wherein the interpolymer resin particles have a gel content ranging from about 0 to about 5.0% by weight based on the weight of said interpolymer resin particles, a VICAT softening temperature ranging from about 85° C. to about 115° C., and a melt index value ranging from about 0.1 to about 4.0 (230° C./5.0 kg)

7. The method according to claim 1, wherein the interpolymer resin particles are formed by polymerizing styrene in the polyolefin resin particles to form an interpenetrating network of polyolefin resin particles and styrenic polymer particles.

8. The method according to claim 1, wherein the first polyolefin is selected from the group consisting of homopolyethylene; copolymers of ethylene and one or more C₃-C₁₀ α-olefins, copolymers of ethylene and one or more C₁-C₄ alkyl(meth)acrylates; copolymers of ethylene and acrylonitrile; copolymers ethylene and vinyl acetate; copolymers of ethylene and butadiene; copolymers ethylene and isoprene; copolymers of ethylene and maleic anhydride; and combinations thereof.

9. The method according to claim 1, wherein the first polyolefin is selected from the group consisting of homopolypropylene; copolymers of propylene and one or more C₂-C₁₀ α-olefins, copolymers of propylene and one or more C₁-C₄ alkyl(meth)acrylates; copolymers of propylene and acrylonitrile; copolymers propylene and vinyl acetate; copolymers of propylene and butadiene; copolymers propylene and isoprene; copolymers of propylene and maleic anhydride; and combinations thereof.

10. The method according to claim 1, wherein the second polyolefin is selected from the group consisting of homopolyethylene; copolymers of ethylene and one or more C₃-C₁₀ α-olefins, copolymers of ethylene and one or more C₁-C₄ alkyl(meth)acrylates; copolymers of ethylene and acrylonitrile; copolymers ethylene and vinyl acetate; copolymers of ethylene and butadiene; copolymers ethylene and isoprene; copolymers of ethylene and maleic anhydride; and combinations thereof.

11. The method according to claim 1, wherein the second polyolefin is selected from the group consisting of homopolypropylene; copolymers of propylene and one or more C₂-C₁₀ α-olefins, copolymers of propylene and one or more C₁-C₄ alkyl(meth)acrylates; copolymers of propylene and acrylonitrile; copolymers propylene and vinyl acetate; copolymers of propylene and butadiene; copolymers propylene and isoprene; copolymers of propylene and maleic anhydride; and combinations thereof.

12. The method according to claim 1, wherein the second polyolefin is a polyolefin selected from the group consisting of ethylene-vinyl acetate copolymers, HDPE, LDPE, LLDPE, VLDPE, polypropylene, and combinations thereof.

13. The method according to claim 1, wherein the second polyolefin is selected from polyethylene and polypropylene.

14. The method according to claim 1, wherein the styrenic polymer is a polymer formed by polymerizing one or more styrenic monomers selected from the group consisting of styrene, α-methylstyrene, ethylstyrene, chlorostyrene, bromostyrene, vinyltoluene, vinylbenzene, and combinations thereof.

15. The method according to claim 1, wherein the styrenic polymer is a polymer formed by polymerizing one or more styrenic monomers with one or more monomers selected from the group consisting of acrylonitrile, methyl methacrylate, butyl acrylate, and methyl acrylate.

16. The method according to claim 1, wherein the blend comprises one or more additives and adjuvants selected from the group consisting of anti-blocking agents, antioxidants, anti-static additives, activators, biodegradation enhancers, zinc oxide, chemical foaming agents, colorants, dyes, filler materials, flame retardants, heat stabilizers, impact modifiers, light stabilizers, light absorbers, lubricants, nucleating agents, pigments, plasticizers, processing aids, slip agents, softening agents, and combinations thereof.

17. The method according to claim 1, wherein the blend components are combined using mixing extrusion.

18. The method according to claim 1, wherein the blend components are combined using melt blending.

19. The method according to claim 1, wherein the film is formed by sheet extrusion.

20. The method according to claim 1, wherein the film is formed by blown film extrusion.

21. The method according to claim 1, comprising the step of laminating or coextruding a second layer over at least one surface of the film to form a multilayer film structure.

22. The method according to claim 1, wherein the film has impact properties greater than a film made of the second polyolefin alone.

23. The method according to claim 1, wherein the film has modulus properties greater than a film made of the second polyolefin alone.

24. The method according to claim 1, wherein the film has tensile properties greater than a film made of the second polyolefin alone.

25. The method according to claim 1, wherein the film has elongation properties greater than a film made of the second polyolefin alone.

26. The method according to claim 1, wherein the film has tear properties greater than a film made of the second polyolefin alone.
